(19) United States
(12) Patent Application Publication
(10) Pub. No.: US 2014/0352656 A1
(43) Pub. Date: Dec. 4, 2014

(54) INTAKE PORT THROTTLING CONTROL FOR DUAL FUEL ENGINES WITH ASYMMETRIC INTAKE PASSAGES

(71) Applicant: Cummins Inc., Columbus, IN (US)

(72) Inventors: Steven J. Kolhouse, Columbus, IN (US); Timothy P. Lutz, Columbus, IN (US)

(21) Appl. No.: 13/909,214

(22) Filed: Jun. 4, 2013

(51) Int. Cl. F02D 9/02

(52) U.S. Cl. CPC F02D 9/02
USPC 123/308

(57) ABSTRACT

Systems and methods for controlling intake flow to dual fuel internal combustion engines are disclosed. The system includes an intake system for providing a charge flow to a plurality of cylinders of the engine through at least two asymmetric intake passages connected to respective intake ports of each cylinder of the engine. At least one or both intake passages includes a throttle to control the intake flow therethrough. The characteristics of the charge flow into the cylinders is controlled by the throttles in response to operating conditions of the dual fuel engine.

### FIELD OF THE INVENTION

The present invention relates generally to dual fuel internal combustion engines, and more particularly is concerned with systems and methods for control of intake flow through asymmetric intake passages connected to respective intake ports of a cylinder of a dual fuel internal combustion engine.

### BACKGROUND

A dual fuel engine is an engine that includes a first fuel source that is utilized as the sole fuel source during certain operating conditions and a second fuel source that is integrated with the first fuel source at other operating conditions. In certain applications, the first fuel source is a diesel fuel and the second fuel source is natural gas. The diesel fuel provides the initial, low load levels of operation and is used for ignition for the natural gas at higher load operations. The substitution of natural gas for diesel fuel improves high load performance and emissions reduction, particularly when the engine is employed at locations where natural gas is abundant or available at low cost.

When the engine is operating in dual fuel mode, natural gas is introduced into the intake system. The air-to-natural gas mixture from the intake is drawn into the cylinder, just as it would be in a spark-ignited engine, but with a leaner air-to-fuel ratio. Near the end of the compression stroke, diesel fuel is injected, just as it would be in a traditional diesel engine. The diesel fuel ignites, and the diesel combustion causes the natural gas to burn. The dual fuel engine combusts a mixture of air and fuel in the cylinders to produce drive torque. A dual fuel engine can operate either entirely on diesel fuel or on the substitution mixture of diesel and natural gas, but cannot operate on natural gas alone. However, the dual fuel engine delivers the same power density, torque curve and transient response as the base diesel engine does.

While prior single fuel engine systems have employed devices that provide swirl and tumble characteristics to the intake flow, such devices are limited in the types of intake flow conditions that are created and have not been employed or controlled for operation of dual fuel engine systems. Thus, there remains a need for additional improvements in systems and methods for providing and controlling intake flow to the intake ports of dual fuel internal combustion engines that, for example, optimize operation, performance, and/or fuel economy.

### SUMMARY

Unique systems and methods are disclosed for dual fuel engines having a plurality of cylinders and at least two intake passages connected to respective intake ports of each cylinder. The intake passages are configured asymmetrically relative to one another, with one intake passage configured to produce swirl characteristics in the charge flow to the respective cylinder and the other intake passage configured to produce tumble characteristics in the charge flow to the respective cylinder.

In various embodiments, at least one of the intake passages also includes a throttle that is actuatable to control the characteristics of the charge flow through the intake passage to the cylinder in response to engine operating conditions. Accordingly, various charge flow characteristics to each cylinder can be created by controlling the throttle(s) in the intake passages. The throttles can be controlled so that the charge flow in the cylinders includes one or more of a high swirl and high tumble characteristic, a low swirl and a low tumble characteristic, a high swirl and low tumble characteristic, a low swirl and high tumble characteristic, a low restriction characteristic for maximum intake flow, a high restriction characteristic for minimum intake flow, and intermediate swirl or tumble characteristics with one of high, intermediate or low tumble or swirl characteristics. The engine operating conditions include any one or more of the operating mode of the internal combustion engine, the gas substitution rate, the quality of the fuel or fuels that provided to the cylinders, the lambda value of the exhaust output, knock conditions, mis-fire conditions, cylinder balance, exhaust output temperatures, load shedding conditions, and emergency shutdown conditions, among others

In other various embodiments, the throttles can be in the form of a plate that when closed covers all, a substantial portion, a majority, or less than half of the cross-sectional flow area defined by the intake passage. The plates may include flat sides, one or more contoured sides, perforated sides, square shape, oval shape, circular shape, or other shape. Each of the throttles can be electronically controlled with an actuator connected to an engine controller that is configured to provide throttle command signals to the actuator to position the throttles to provide the desired amount of charge flow with tumble and/or swirl characteristics to each cylinder in response to engine operating conditions.

These and other aspects, embodiments, forms, features and characteristics of the systems and methods disclosed herein as discussed further below.

### BRIEF DESCRIPTION OF THE DRAWINGS

FIG. 1 is a schematic illustration of a portion of an internal combustion engine system.

FIG. 2 is a schematic illustration of another portion of the internal combustion engine system of FIG. 1 showing various embodiments of a dual fueling system.

FIGS. 3A-3C are schematic illustrations of a cylinder of the internal combustion engine system of FIG. 1 showing one embodiment of an intake passage including a throttle arrangement and the charge flow characteristics in the combustion chamber.

FIGS. 4A-4E are schematic illustrations of various intake passage throttling configurations.

FIG. 5 is a flow diagram of a procedure for regulating charge flow characteristics to the combustion chambers of the plurality of cylinders of the systems of FIGS. 1-2 using the throttle arrangements and configuration of FIGS. 3A-4E.

### DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

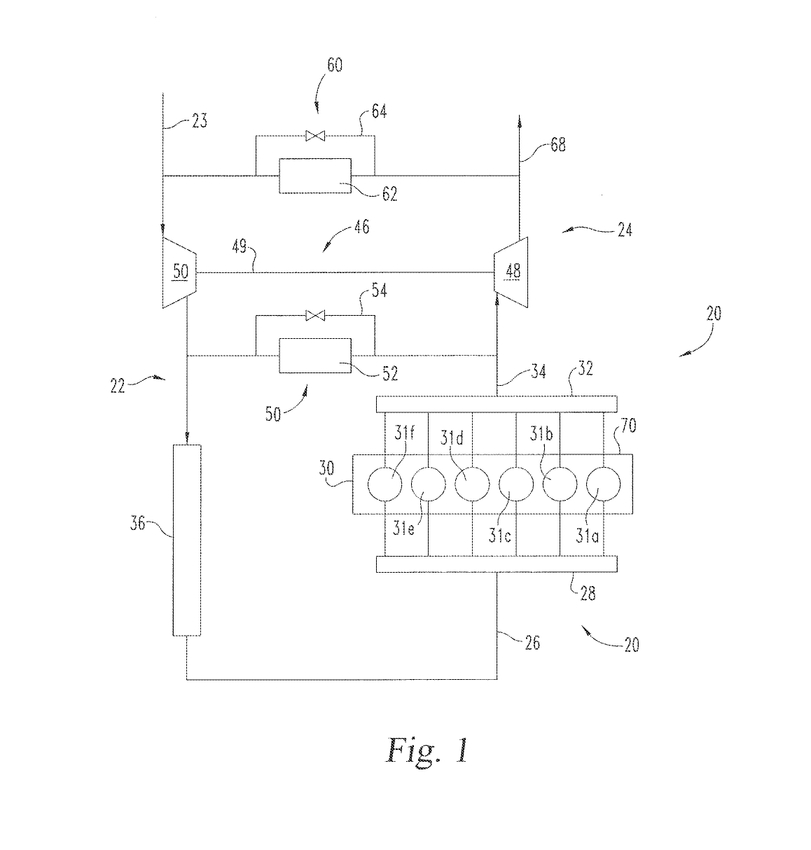

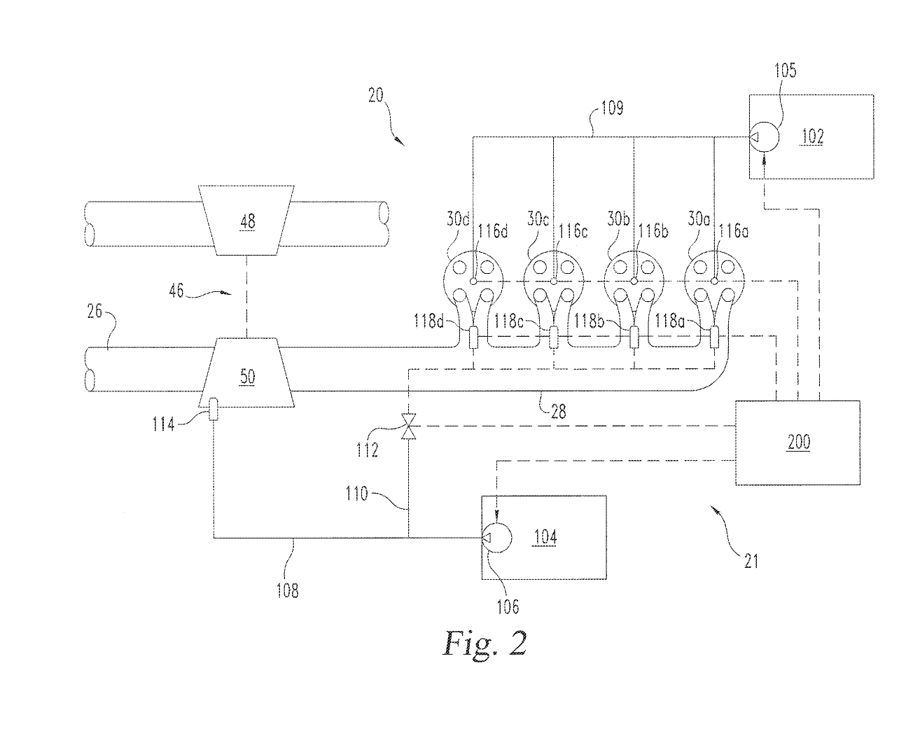

With reference to FIG. 1, an internal combustion engine system 20 is illustrated in schematic form. In FIG. 2, a fueling system 21 is shown in schematic form that is operable with internal combustion engine system 20 to provide fueling for engine 30 from a first fuel source 102 and a second fuel source 104. Internal combustion engine system 20 includes engine 30 connected with an intake system 22 for providing a charge flow to engine 30 and an exhaust system 24 for output of exhaust gases. In certain embodiments, the engine 30 includes a lean combustion engine such as a diesel cycle engine that uses a primary fuel such as diesel fuel and a secondary fuel such as natural gas. The secondary fuel can be, for example, liquid natural gas, compressed natural gas, bio-gas, methane, propane or ethanol. However, other types of primary and secondary fuels are not precluded. In the illustrated embodiment, the engine 30 includes six cylinders 31a-31f in an in-line arrangement. However, the number of cylinders (collectively referred to as cylinders 31) may be any number, and the arrangement of cylinders 31 may be any arrangement, and is not limited to the number and arrangement shown in FIG. 1.

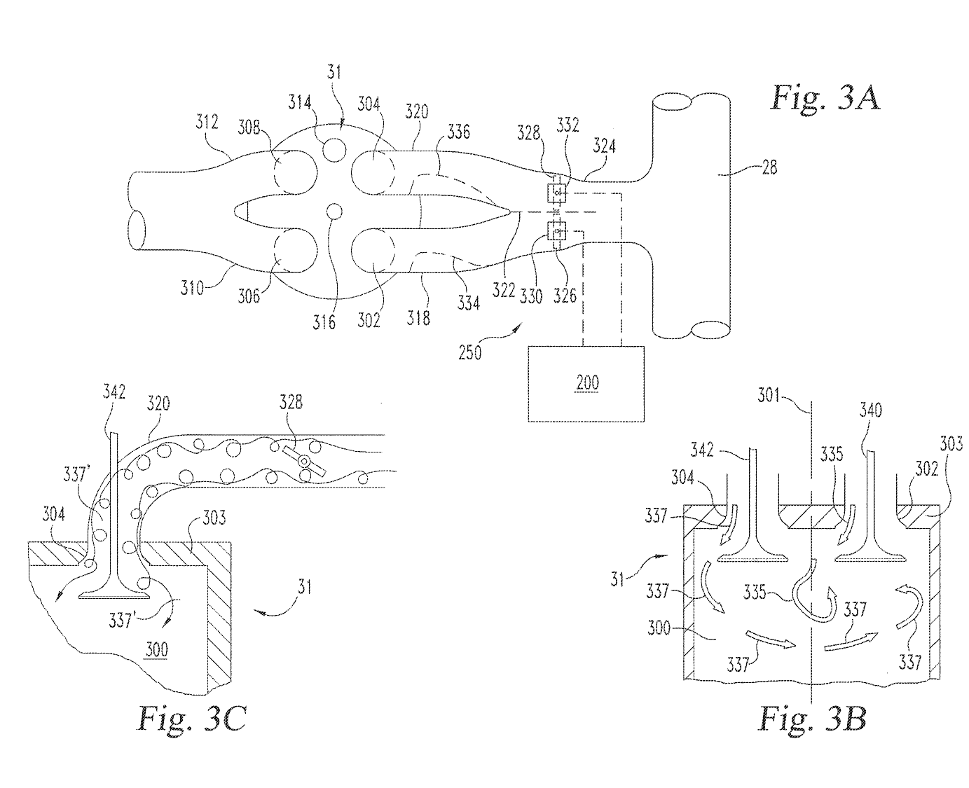

Engine 30 includes an engine block 70 that at least partially defines the cylinders 31. A plurality of pistons (not shown) may be slidably disposed within respective cylinders 31 to reciprocate between a top-dead-center position and a bottom-dead-center position, and a cylinder head 303 (FIG. 3B) may be associated with each cylinder 31. Each of the cylinders 31, its respective piston, and the cylinder head form a combustion chamber 300. In the illustrated embodiment, engine 30 includes six such combustion chambers. However, it is contemplated that engine 30 may include a greater or lesser number of cylinders and combustion chambers and that cylinders and combustion chambers may be disposed in an “in-line” configuration, a “V” configuration, or in any other suitable configuration.

In one embodiment, engine 30 is a four stroke engine. That is, for each complete engine cycle (i.e., for every two full crankshaft rotations), each piston of each cylinder 31 moves through an intake stroke, a compression stroke, a combustion or power stroke, and an exhaust stroke. Thus, during each complete cycle for the depicted six cylinder engine, there are six strokes during which air is drawn into individual combustion chambers from intake supply conduit 26 and six strokes during which exhaust gas is supplied to exhaust manifold 32.

The engine 30 includes cylinders 31 connected to the intake system 22 to receive a charge flow and connected to exhaust system 24 to release exhaust gases produced by combustion of the primary and/or secondary fuels. Exhaust system 24 may provide exhaust gases to a turbocharger 46, although a turbocharger is not required. In still other embodiments, multiple turbochargers are included to provide high pressure and low pressure turbocharging stakes that compress the intake flow.

Furthermore, exhaust system 24 can be connected to intake system 22 with one or both of a high pressure exhaust gas recirculation (EGR) system 50 and a low pressure EGR system 60. EGR systems 50, 60 may include a cooler 52, 62 and bypass 54, 64, respectively. In other embodiments, one or both of EGR systems 50, 60 are not provided. When provided, EGR system(s) 50, 60 provide exhaust gas recirculation to engine 30 in certain operating conditions. In any EGR arrangement during at least certain operating conditions, at least a portion the exhaust output of cylinder(s) 31 is recirculated to the engine intake system 22. In the high pressure EGR system 50, the exhaust gas from the cylinder(s) 31 takes off from exhaust system 24 upstream of turbine 48 of turbocharger 46 and combines with intake flow at a position downstream of compressor 50 of turbocharger 46 and upstream of an intake manifold 28 of engine 30. In the low pressure EGR system 60, the exhaust gas from the cylinder(s) 31a-31f takes off from exhaust system 24 downstream of turbine 48 of turbocharger 46 and combines with intake flow at a position upstream of compressor 50 of turbocharger 46. The recirculated exhaust gas may combine with the intake gases in a mixer (not shown) of intake system 22 or by any other arrangement. In certain embodiments, the recirculated exhaust gas returns to the intake manifold 28 directly.

Intake system 22 includes one or more inlet supply conduits 26 connected to an engine intake manifold 28, which distributes the charge flow to cylinders 31 of engine 30. Exhaust system 24 is also coupled to engine 30 with an engine exhaust manifold 32. Exhaust system 24 includes an exhaust conduit 34 extending from exhaust manifold 32 to turbine 48 of turbocharger 46. An aftertreatment system (not shown) can be connected with an outlet conduit 68. The aftertreatment system may include, for example, oxidation devices (DOC), particulate removing devices (DPF, CDPF), constituent absorbers or reducers (SCR, AMOX, LNT), three-way catalysts for stoichiometric spark ignited engines, attenuation devices (mufflers), controllers, etc., if desired.

In one embodiment, exhaust conduit 34 is flowed coupled to exhaust manifold 32, and may also include one or more intermediate flow passages, conduits or other structures. Exhaust conduit 34 extends to turbine 48 of turbocharger 46. Turbocharger 46 may be any suitable turbocharger known in the art, including variable-geometry turbine turbochargers and waste-gated turbochargers. Turbocharger 46 may also include multiple turbochargers. Turbine 48 is connected via a shaft 49 to compressor 50 that is flow coupled to inlet supply conduit 26. Inlet supply conduit 26 may include a charge air cooler 36 downstream from compressor 50 and the EGR mixing location(s), if provided. In another embodiment, a charge air cooler 36 is located in the intake system 22 upstream of the EGR mixing locations.

In operation of internal combustion engine system 20, fresh air is supplied through inlet air supply conduit 23. The fresh air flow or combined flows can be filtered, unfiltered, and/or conditioned in any known manner, either before or after mixing with the EGR flow from EGR systems 50, 60 when provided. The intake system 22 may include components configured to facilitate or control introduction of the charge flow to engine 30, and may include an induction valve or throttle (not shown), one or more compressors 50, and charge air cooler 36. The induction valve may be connected upstream or downstream of compressor 50 via a fluid passage and configured to regulate a flow of atmospheric air and/or combined air/EGR flow to engine 30. Compressor 50 may be a fixed or variable geometry compressor configured to receive air or combined flow from the induction valve and compress the air or combined flow to a predetermined pressure level before engine 30. Charge air cooler 36 may be disposed within inlet air supply conduit 26 between engine 30 and compressor 50, and embody, for example, an air-to-air heat exchanger, an air-to-liquid heat exchanger, or a combination of both to facilitate the transfer of thermal energy to or from the flow directed to engine 30. The ambient air or combined air/EGR flow is pressurized with compressor 50 and sent through charge air cooler 36 and supplied to engine 30 through intake supply conduit 26 to engine intake manifold 28.

With reference to FIG. 2, a fuel system 21 for providing dual fuels to engine 30 is shown. Fuel system 21 includes a first fuel source 102 and a second fuel source 104. First fuel source 102 is configured to provide a flow of a first fuel to cylinders 31 with one or more injectors at or near each cylinder. Second fuel source 104 is connected to intake system 22 with injectors near each of the cylinders 31 or an injector at compressor 50. In certain embodiments, the cylinders 31 each include at least one of a port injector or a direct injector for delivering fuel to the combustion chamber thereof from a primary fuel source, such as first fuel source 102. In addition, the cylinders 31 may include at least one second injector that is a port injector or direct injector for delivering fuel to its combustion chamber from second fuel source 104. Alternatively, an intake injector at compressor 50 can be provided for delivery or induction of fuel from the second fuel source 104 with the charge flow delivered to cylinders 31.

The fueling from the first fuel source 102 is controlled to provide the sole fueling at certain operating conditions of engine 30, and fueling from the second fuel source 104 is provided to substitute for fueling from the first fuel source 102 at other operating conditions to provide a dual flow of fuel to engine 30. In embodiments where the first fuel source 102 is diesel fuel and the second fuel source 104 is natural gas, a control system including controller 200 is configured to control the flow of liquid diesel fuel from first source 102 and the flow of gaseous fuel from second source 104 in accordance with engine speed, engine loads, intake manifold pressures, and fuel pressures, for example. One example of a gas substitution control system and method for a dual fuel engine is disclosed in PCT Publication No. WO 2011/153069 published on Dec. 8, 2011, which is incorporated herein by reference.

A direct injector, as utilized herein, includes any fuel injection device that injects fuel directly into the cylinder volume, and is capable of delivering fuel into the cylinder volume when the intake valve(s) and exhaust valve(s) are closed. The direct injector may be structured to inject fuel at the top of the cylinder or laterally of the cylinder. In certain embodiments, the direct injector may be structured to inject fuel into a combustion pre-chamber. Each cylinder 31, such as the illustrated cylinders 31a-d in FIG. 2 (cylinders 31e and 31f omitted for brevity, it being understood that any cylinder arrangement and number as discussed herein is contemplated) may include one or more direct injectors 116a-116d, respectively. The direct injectors 116a-116d may be the primary fueling device for first fuel source 102 for the cylinders 31a-31d. Although not shown in FIG. 2, alternatively or additionally direct injectors 116a-116d may be the primary fueling device for second fuel source 104.

A port injector, as utilized herein, includes any fuel injection device that injects fuel outside the engine cylinder in the intake manifold to form the air-fuel mixture. The port injector sprays the fuel towards the intake valve. During the intake stroke, the downwards moving piston draws in the air/fuel mixture past the open intake valve and into the combustion chamber. Each cylinder 31 may include one or more port injectors 118a-118d, respectively. Although not shown in FIG. 2, the port injectors 118a-118d may be the primary fueling device for first fuel source 102 to the cylinders 31a-31d. In the illustrated embodiment, port injectors 118a-118d are shown as one embodiment of a primary fueling device for the second fuel source 104 to the cylinders 31a-31d. Alternatively, the second fuel source 104 can be connected to intake system 22 with a natural gas injector 114 upstream of intake manifold 28, such as at the inlet to compressor 50.

In certain embodiments, each cylinder 31 includes one of a port or direct injector that is capable of providing all of the designed primary fueling amount from first fuel source 102 for the cylinders 31 at any operating condition. Second fuel source 104 provides a flow of a second fuel to each cylinder 31 through a natural gas injector upstream of intake manifold 28 or by at least one additional port or direct injector at cylinders 31 to provide a second fuel flow to the cylinders 31 to achieve desired operational outcomes, such as improved efficiency, improved fuel economy, improved high load operation, and other outcomes.

One embodiment of system 20 includes fuel system 21 that includes at least one fuel source 102 to provide a primary fuel flow to all the cylinders 31 and a second fuel source 104 that provides a second fuel flow to all the cylinders 31 in addition to the primary fuel flow under certain operating conditions. First fuel source 102 includes a first fuel pump 105 that is connected to controller 200, and the second fuel source 104 includes a second fuel pump 106 that is connected to controller 200. Each of the cylinders 31 includes an injector, such as direct injectors 116a-116d associated with each of the illustrated cylinders 31a-31d of FIG. 2. Direct injectors 116a-116d are electrically connected with controller 200 to receive fueling commands that provide a fuel flow to the respective cylinder 31 in accordance with a fuel command determined according to engine operating conditions and operator demand by reference to fueling maps, control algorithms, or other fueling rate/amount determination source stored in controller 200. First fuel pump 105 is connected to each of the direct injectors 116a-116d with a first fuel line 109. First fuel pump 105 is operable to provide a first fuel flow from first fuel source 102 to each of the cylinders 31a-31d in an amount determined by controller 200 that achieves a desired power and exhaust output from cylinders 31.

Furthermore, cylinders 31a-31d may include a second injector, such as port injectors 118a-118d, electrically connected with controller 200. Second fuel pump 106 is connected to port injectors 118a-118d with a second fuel line 110. A control valve 112 can be provided in fuel line 110 and/or at one or more other locations in fuel system 21 that is connected to controller 200. Second fuel pump 106 is operable to provide a second fuel flow from second fuel source 104 in an amount determined by controller 200 that achieves a desired power and exhaust output from cylinders 31. In an alternative embodiment, in lieu of port injectors 118a-118d, an injector 114 is provided at the inlet to compressor 150 and is operable along with second fuel pump 106 to provide the second flow of fuel through fuel line 108 to the intake system 22 for transport to cylinders 31. In still another embodiment, second fuel pump 106 is omitted and fuel is supplied to injector 114 under pressure from a pressurized second fuel source 104. The fuel pumps 105, 106, control valve(s) 112, and/or injectors 114, 116, 118 can be operable to regulate the amount, timing and duration of the flows of the first and second fuels to cylinders 31 to provide the desired power and exhaust output.

Referring to FIGS. 3A-3B, there is shown one of the cylinders 31, and an intake passage throttle control system 250. It should be understood that intake passage throttle control system 250 can be connected to each of the cylinders 31 of engine 30 to provide control of the charge flow through the intake passages to each of the cylinders 31. Each cylinder 31 includes a combustion chamber 300 that houses a piston (not shown.) Cylinder 31 also includes first and second intake ports 302, 304 that open through cylinder head 303 into combustion chamber 300 and first and second exhaust ports 306, 308. It should be understood however, that more or fewer ports are also contemplated. Exhaust ports 306, 308 are connected to exhaust passages 310, 312, respectively, which connect to exhaust manifold 32. Cylinder 31 may also includes one or more fuel injection ports 314 and plug ports 316.

First intake port 302 is connected to a first intake passage 318 and second intake port 304 is connected to a second intake passage 320. Intake passages 318, 320 can be formed by separate tube members, by a dividing wall 322 in a single tube member or tube member portion 324, or a combination thereof such as shown in FIG. 3A. Charge air from intake manifold 28 is delivered to combustion chamber 300 through intake ports 302, 304 from the respective intake passage 318, 320.

Each of the intake passages 318, 320 includes a throttle arrangement to control the amount of intake charge flow therethrough. In the illustrated embodiment, first intake passage 318 includes a first throttle 326 and second intake passage 320 includes a second throttle 328. Each of throttles 326, 328 is connected to respective ones of first and second actuators 330, 332 that are electronically connected to and controlled by controller 200.

Furthermore, intake passage 318, 320 include one or more flow characteristic inducing elements 334, 336 that induce a characteristic to the charge flow passing therethrough. In the illustrated embodiment, first intake passage 318 includes a tumble flow inducing feature 334 that creates a tumble characteristic to the charge flow entering through first intake port 304. Second intake passage 320 includes a swirl flow inducing feature 336 that creates a swirl characteristic to the charge flow entering through second intake port 304. Flow characteristic inducing elements 334, 336 can be formed by, for example, one or more protuberances in the respective intake passage that direct the charge flow as shown. It is further contemplated that the flow characteristic inducing elements 334, 336 can be formed by valves, gates, the intake passage shape, or other suitable means.

As further shown in FIG. 3B, cylinder 31 extends along a central longitudinal axis 301. The tumble inducing feature 334 is configured so that the charge flow is directed around intake port valve 340 toward longitudinal axis 301 as is enters combustion chamber 300 and tumbles in a direction that parallels or generally follows the directions of axis 301, as indicated by arrows 335, between the piston and cylinder head 303. The swirl inducing feature 336 is configured so that the charge flow is directed around intake port valve 342 toward the inner sidewalls of combustion chamber 300 and swirls in a direction around axis 301, as indicated by arrows 337. By controlling the amounts of charge flow with tumble and swirl characteristics introduced into combustion chamber 300, the homogeneity of the mixture of the charge flow with the first fuel, or the combination of the first and second fuels, can be controlled to improve combustion of the fuel and charge flow mixture in response to engine operating conditions.

Referring to FIG. 3C, there is shown intake passage 320 connected with intake port 304 of cylinder 31. As discussed above, intake passage 320 includes swirl inducing feature 336 configured to direct the charge flow around intake port valve 342 toward the inner sidewalls of combustion chamber 300 to swirl in a direction around axis 301. In some load or operating conditions of engine 30, it may be desired to provide all charge flow from intake passage 318 having tumble flow, such as when operating in fueling mode with high flow rate from the second fuel source 104. However, there may be load conditions which require more charge flow than can be provided by intake passage 318 alone. In response, throttle 328 in intake passage 320 can be partially opened as shown in FIG. 3C in order to allow additional charge flow. Furthermore, the partially opened condition of throttle 328 induces a tumble characteristic to the swirl flow received from intake passage 320, as indicated by arrows 337′. As a result, charge flow is admitted from intake passage 318 with tumble characteristic and the partially opened intake passage 320 introduces swirl flow that also has a tumble characteristic, creating a favorable charge flow profile for engine operation with high fueling from second fuel source 104.

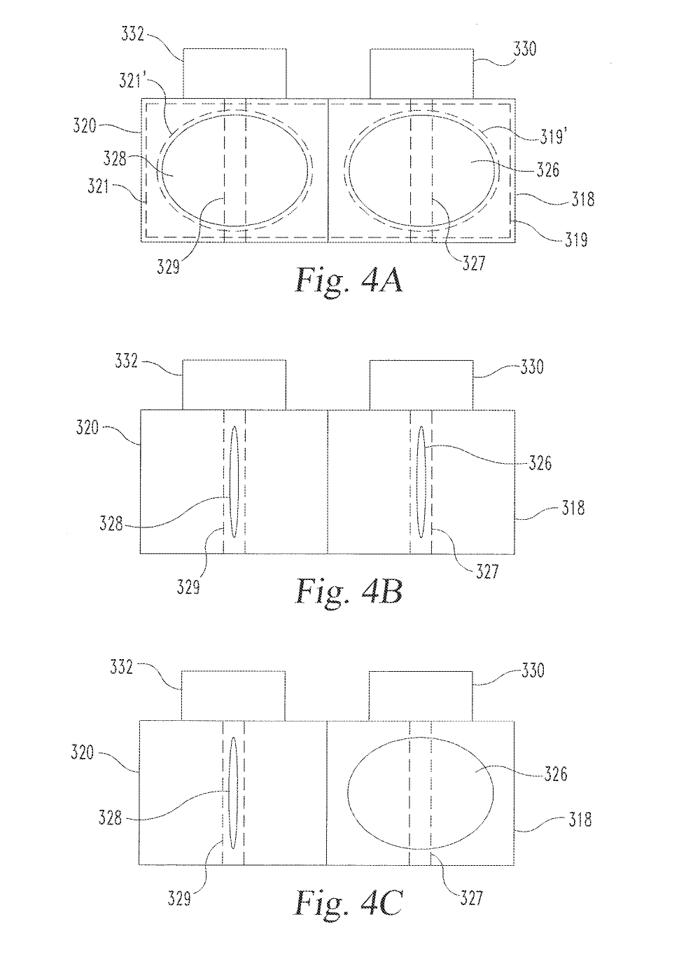

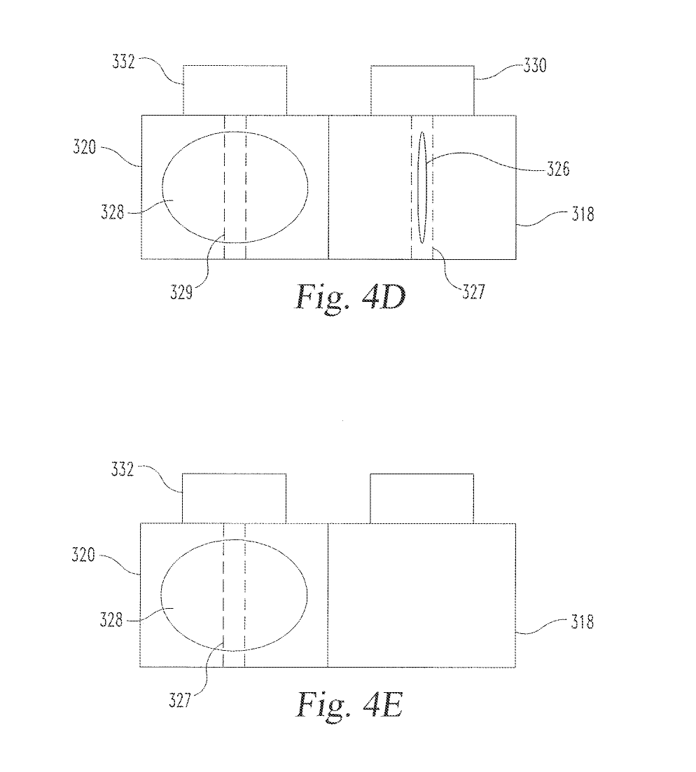

Referring to FIGS. 4A-4E, various possible arrangements for throttle positions of throttles 326, 328 are shown that provide difference tumble and swirl characteristics to the charge flow into combustion chamber 300. As discussed above, the position of first and second throttles 326, 328 are controlled with respective ones of the actuators 330, 332. Furthermore, as shown in FIG. 4A, each of the intake passages 318, 320 can define a cross-sectional charge flow area 319, 321, respectively, that is significantly larger than the size of the respective throttle 326, 328. Alternatively, intake passages 318, 320 can define a cross-sectional charge flow area 319′, 321′ that is the same or substantially the same size as the respective throttle 326, 328. The reference numerals 319, 321 are used hereinafter to refer to any size cross-sectional charge flow area.

In one embodiment, throttles 326, 328 are each formed by a plate-type structure mounted to a shaft 327, 329, respectively, that is connected to the respective actuator 330, 332. One or both of the plates can cover all or substantially all (more than 90%) of the respective charge flow area 319, 321 in the closed position. Alternatively, one or both of the plates can cover a major portion (50% or more) of the respective charge flow area 319, 321 in the closed position. The plate structures of throttles 326, 328 can be solid as shown, or include one or more perforations. The plate structures can also include one or more major surfaces (surfaces that face toward or away from the flow direction in the closed position) that are flat or contoured. The outer perimeter of the plates can define an oval, round, square, irregular, or other suitable shape.

In the throttle positions of FIG. 4A, throttles 326, 328 are both closed to minimize charge flow through intake passages 318, 320. In FIG. 4B, throttles 326, 328 are both in an open position so that the charge flow through intake passages 318, 320 is maximized. In FIG. 4C, throttle 326 is closed and throttle 328 is open, minimizing the tumble characteristic in the charge flow from intake passage 318 while maximizing the swirl characteristic in the charge flow from intake passage 320. In FIG. 4D, throttle 326 is opened and throttle 328 is closed, maximizing the tumble characteristic in the charge flow from intake passage 318 while minimizing the swirl characteristic in the charge flow from intake passage 320. In addition, it is contemplated that one or both of throttles 326, 328 can be moved to an intermediate position that is between its open and closed positions to provide a partial charge flow therethrough. Examples of intermediate positions include 25% open, 50%, open, and 75% open, to name just a few. Any degree of opening of the throttle 326, 328 between its opened and closed positions is contemplated.

Furthermore, one or more of intake passages 318, 320 can be configured without a throttle 326, 328. For example, in FIG. 4E intake passage 318 is provided without throttle 326 so that charge flow with tumble characteristics through intake passage 318 is always provided at a maximum level. In an alternative embodiment, intake passage 318 includes a throttle 326 and intake passage 320 does not so that charge flow with a swirl characteristic is always provided. In yet, a further embodiment, the intake passage 318, 320 lacking a throttle also lacks any swirl or tumble flow inducing features to the charge flow therethrough.

As discussed above, the positioning of each of throttles 326, 328 is provided by the respective actuator 330, 332 via control commands from controller 200. In certain embodiments of the systems disclosed herein, controller 200 is structured to perform certain operations to control engine operations and fueling of cylinders 31 with fueling system 21 to provide the desired speed and torque outputs. In certain embodiments, the controller 200 forms a portion of a processing subsystem including one or more computing devices having memory, processing, and communication hardware. The controller 200 may be a single device or a distributed device, and the functions of the controller 200 may be performed by hardware or software. The controller 200 may be included within, partially included within, or completely separated from an engine controller (not shown). The controller 200 is in communication with any sensor or actuator throughout the systems disclosed herein, including through direct communication, communication over a datalink, and/or through communication with other controllers or portions of the processing subsystem that provide sensor and/or actuator information to the controller 200.

Certain operations described herein include operations to determine one or more parameters. Determining, as utilized herein, includes receiving values by any method known in the art, including at least receiving values from a datalink or network communication, receiving an electronic signal (e.g. a voltage, frequency, current, or PWM signal) indicative of the value, receiving a software parameter indicative of the value, reading the value from a memory location on a non-transient computer readable storage medium, receiving the value as a run-time parameter by any means known in the art, and/or by receiving a value by which the interpreted parameter can be calculated, and/or by referencing a default value that is interpreted to be the parameter value.

The schematic flow description which follows provides an illustrative embodiment of a method for providing intake passage throttle control to the intake ports of cylinders 31 of a dual fuel internal combustion engine system 20. As used herein, a dual fuel system 21 is a fueling system in which a dual fueling mode is provided where each of the cylinders 31 of engine 30 receives a first fuel flow during all operating conditions and a second fuel flow in addition to the first fuel flow under certain other operating conditions. However, it is contemplated that the dual fueling system 21 can be operated in a single fuel mode from first fuel source 102 upon operator selection. Operations illustrated are understood to be exemplary only, and operations may be combined or divided, and added or removed, as well as re-ordered in whole or part, unless stated explicitly to the contrary herein. Certain operations illustrated may be implemented by a computer such as controller 200 executing a computer program product on a non-transient computer readable storage medium, where the computer program product comprises instructions causing the computer to execute one or more of the operations, or to issue commands to other devices to execute one or more of the operations.

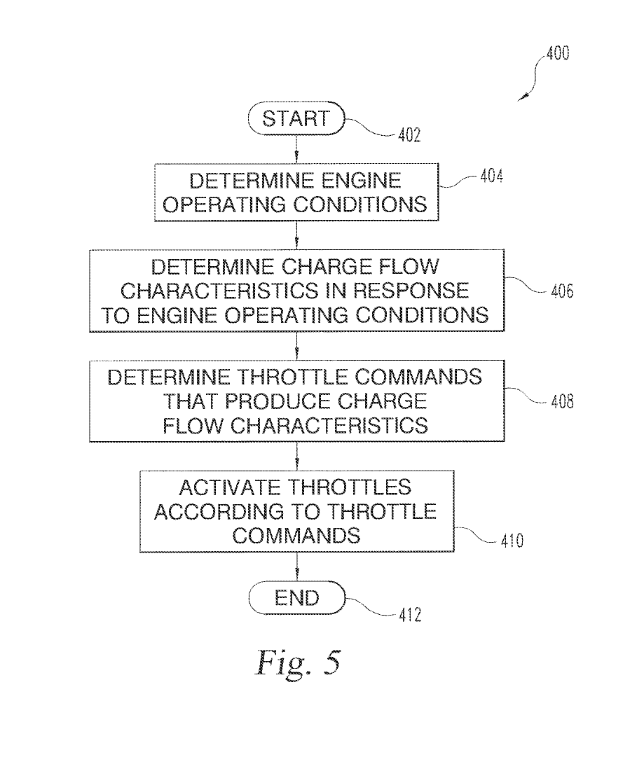

In FIG. 5, one embodiment of a flow diagram for operating engine 30 with dual fuel system 21 and an intake passage throttle control system 250 is disclosed. Procedure 400 starts at 402 upon, for example, starting of engine 30. At operation 404 the operating conditions of engine 30 are determined. The engine operating conditions can include, for example, engine operating parameters that can be affected, altered, made more efficient, improved, or otherwise controlled by actuating throttles 326, 328 to a position that provides desired tumble and/or swirl characteristics to the charge flow through intake passages 318, 320 of each cylinder 31. Examples of engine operating conditions include the fueling provided to cylinders 31 from first fuel source 102, the fueling provided to cylinders 31 from second fuel source 104, and the fuel substitute rate during a dual fueling conditions. The fuel substitution rate is the rate at which fuel from second fuel source 104 is substituted for fuel from first fuel source 102 to achieve the desired speed and torque output to meet load conditions. Other engine operating conditions can include an indication of the exhaust output Lambda value, knock conditions, mis-fire conditions, cylinder balance, exhaust output temperatures, load shedding conditions, emergency shutdown conditions, and the quality and/or composition of the second fuel.

Based on engine operating conditions determined at operation 404, procedure 400 continues at operation 406 in which charge flow characteristics are determined at operation 408 in response to the engine operating condition(s). For example, under certain operating conditions, charge flow in each cylinder 31 with a high swirl characteristic and a high tumble characteristic may be desired. Certain other operating conditions may dictate a high swirl characteristic and low tumble characteristic to the charge flow in each cylinder 31. Still other operating conditions may dictate a low swirl characteristic and high tumble characteristic to the charge flow in each cylinder 31. Other operating conditions may dictate a low swirl characteristic and low tumble characteristic to the charge flow in each cylinder 31. It is further possible to determine charge flow characteristics that are intermediate the high and low swirl characteristics and the high and low tumble characteristics.

In one specific embodiment with a dual fuel internal combustion engine system 20, there are operating conditions in which fueling to the plurality of cylinders 31 is provided entirely from first fuel source 102 such as at low load conditions. In one embodiment, low load conditions range from about 0% to 25% of the maximum load of engine 30. However, in other embodiments, fuel can be provided from first fuel source 102 and second fuel source 104 in low load conditions depending on engine characteristics, operating conditions, and application in which the engine is employed. Other engine operating conditions are dual fueling conditions in which fueling is provided to the plurality of cylinders 31 from the first fuel source 102 and the second fuel source 104. In one specific embodiment, an intermediate loading of engine 30 utilizes the first fuel at a first generally constant amount and the second fuel at a variable amount that increases as the loading on engine 30 increases. In one example, intermediate loading conditions of engine 30 ranges from about 25% to 90% of the maximum engine load. During this intermediate loading, the second fuel is substituted for the first fuel to meet the load requirements exceeding 25%, and the second fuel amount increases as the load increases to meet output demand, while the first fueling rate remains generally constant over the intermediate loading to provide desired combustion properties. A high loading condition of the dual fuel operating mode utilizes an increasing amount of both the first and second fuels to meet output requirements. In one specific example, the high loading condition ranges from about 90% to 100% of maximum engine loading.

In one implementation, the operator can select whether to operate in a single fuel mode so that fuel is provided entirely from first fuel source 102 or a dual fuel mode in which fuel from both sources 102, 104 can be employed at least during certain operating conditions. In a specific embodiment where first fuel 102 is diesel fuel and a single fuel mode is selected, at low load and/or cold start conditions, engine 30 operates only with diesel fuel from first fuel source 102. In these low load/cold start conditions, a high swirl characteristic and no or low tumble characteristic to the charge flow can be provided to ensure desired mixing of the first fuel with the charge flow for combustion in combustion chamber 31. As the engine load increases to the rated load, the other intake port inducing swirl flow can be opened to provide additional air flow to meet demand.

Once the charge flow characteristics are determined at operation 406, procedure 400 continues at operation 408 in which throttle commands are determined that position or orient throttles 326, 328 at the appropriate positions in intake passages 318, 320 to produce the desired charge flow characteristics in response to the engine operating conditions. The determined throttle commands are then communicated to actuators 330, 332 at operation 410 so that throttles 326, 328 are moved to the appropriate position or positions to produce the desired charge flow characteristics for the charge flow through each of the intake passages 318, 320 to the respective cylinder 31. Procedure 400 ends at operation 412 when operation of engine 30 is terminated.

Various aspects of the systems and methods disclosed herein are contemplated. For example, one aspect relates to a method that includes operating an internal combustion engine system. The internal combustion engine includes an engine with a plurality of cylinders and at least two fuel sources operably connected to the internal combustion engine system to provide a first fuel and a second fuel to each of the plurality of cylinders. The internal combustion engine system further includes an exhaust system and an intake system. The intake system is coupled to each of the plurality of cylinders with a first intake passage and a second intake passage connected to corresponding ones of first and second intake ports of the respective cylinder to provide a charge flow from the intake system to a combustion chamber of the respective cylinder. The method further includes inducing a tumble characteristic to the charge flow in the first intake passage; inducing a swirl characteristic to the charge flow in the second intake passage; determining an engine operating condition according to engine operating parameters; and for each of the plurality of cylinders, controlling a first throttle in the first intake passage and a second throttle in the second intake passage in response to the engine operating condition to regulate the charge flow from the first intake passage with the tumble characteristic to the combustion chamber and to regulate the charge flow from the second intake passage with the swirl characteristic to the combustion chamber.

According to another aspect, a system is disclosed that includes an engine having a plurality of cylinders, an intake system configured to direct a charge flow to all of the plurality of cylinders, an exhaust system configured to receive exhaust from a first portion of the plurality of cylinders and outlet the exhaust to atmosphere, a dedicated exhaust gas recirculation system configured to receive exhaust from a second portion of the plurality of cylinders and direct the exhaust from the second portion of the plurality of cylinders to the intake system, and a fuel system including at least one fuel source that is connected to each of the plurality of cylinders to provide a first fuel flow, the at least one fuel source further being connected to the second portion of the plurality of cylinders to provide a second fuel flow in addition to the first fuel flow.

While the invention has been illustrated and described in detail in the drawings and foregoing description, the same is to be considered as illustrative and not restrictive in character, it being understood that only certain exemplary embodiments have been shown and described. Those skilled in the art will appreciate that many modifications are possible in the example embodiments without materially departing from this invention. Accordingly, all such modifications are intended to be included within the scope of this disclosure as defined in the following claims.

In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A method, comprising:
operating an internal combustion engine system including an engine with a plurality of cylinders and at least two fuel sources operably connected to the internal combustion engine system to provide a first fuel and a second fuel to each of the plurality of cylinders, the internal combustion engine system further including an exhaust system and an intake system, wherein the intake system is coupled to each of the plurality of cylinders with a first intake passage and a second intake passage connected to corresponding ones of first and second intake ports of the respective cylinder, the first and second intake passages providing a charge flow from the intake system to a combustion chamber of the respective cylinder;
inducing a tumble characteristic to the charge flow in the first intake passage and a swirl characteristic to the charge flow in the second intake passage;
determining an engine operating condition according to engine operating parameters; and
for each of the plurality of cylinders, controlling at least one of a first throttle in the first intake passage and a second throttle in the second intake passage in response to the engine operating condition, the first throttle regulating an amount of charge flow with the tumble characteristic from the first intake passage to the combustion chamber and the second throttle regulating an amount of charge flow with the swirl characteristic from the second intake passage to the combustion chamber.

2. The method of claim 1, wherein the first fuel is diesel fuel and the second fuel is selected from the group consisting of natural gas, liquid natural gas, compressed natural gas, bio-gas, methane, propane and ethanol.

3. The method of claim 2, wherein determining the engine operating condition includes determining at least one of a gas substitution rate, a knock condition, a mis-fire condition, a balance of the plurality of cylinders, an exhaust output temperature, an exhaust lambda value, a load shedding condition, and an emergency shutdown condition.

4. The method of claim 1, further comprising controlling the first throttle in the first intake passage by placing the first throttle in a closed position and controlling the second throttle in the second intake passage by placing the second throttle in an open position to provide charge flow to the combustion chamber with a low tumble characteristic and a high swirl characteristic.

5. The method of claim 1, further comprising controlling the first throttle in the first intake passage by placing the first throttle in an open position and controlling the second throttle in the second intake passage by placing the second throttle in a closed position to provide the charge flow to the combustion chamber with a high tumble characteristic and a low swirl characteristic.

6. The method of claim 1, further comprising controlling the first throttle in the first intake passage by placing the first throttle in an open position and controlling the second throttle in the second intake passage by placing the second throttle in an open position to provide the charge flow to the combustion chamber with a high tumble characteristic and a high swirl characteristic.

7. The method of claim 1, further comprising controlling the first throttle in the first intake passage and the second throttle in the second intake passage includes by placing the first throttle in a closed position and by placing the second throttle in a closed position.

8. A system, comprising:
an internal combustion engine including a plurality of cylinders;
an exhaust system configured to receive exhaust from the plurality of cylinders;
a fuel system including a first fuel source operable to provide a first fuel to the plurality of cylinders and a second fuel source operable to provide a second fuel to the plurality of cylinders in addition to the first fuel;
an intake system configured to direct a charge flow to the plurality of cylinders, wherein the intake system is coupled to each of the plurality of cylinders with a first intake passage and a second intake passage connected to corresponding ones of first and second intake ports of the respective cylinder, the first and second intake passages providing a charge flow from the intake system to a combustion chamber of the respective cylinder, wherein for each of the plurality of cylinders:
the first intake passage connected thereto includes at least one swirl characteristic inducing element configured to generate a swirl characteristic in the charge flow received by the combustion chamber, wherein the first intake passage further includes a first electronically controllable throttle to regulate the charge flow therethrough; and
the second intake passage connected thereto includes at least one tumble characteristic inducing element configured to generate a tumble characteristic in the charge flow received by the combustion chamber, wherein the second intake passage further includes a second electronically controllable throttle to regulate the charge flow therethrough.

9. The system of claim 8, further comprising a first electronic actuator connected to the first throttle and a second electronic actuator connected to the second throttle.

10. The system of claim 9, further comprising a controller connected to the first actuator and to the second actuator.

11. The system of claim 8, wherein the first fuel is diesel fuel and the second fuel is natural gas.

12. The system of claim 11, wherein the first fuel source is connected to each of the plurality of cylinders with one of a direct injector and a port injector.

13. The system of claim 12, wherein the second fuel source is connected to the intake system with a port injector at each of the plurality of cylinders.

14. The system of claim 12, wherein the intake system includes a compressor for compressing an intake flow and the second fuel source is connected to the intake system at an inlet of the compressor.

15. The system of claim 8, wherein each of the first and second intake passages defines a cross-sectional charge flow area and the first and second throttles are configured to substantially cover the cross-sectional charge flow area of the respective intake passage when in a closed position.

16. The system of claim 8, wherein each of the first and second intake passages defines a cross-sectional charge flow area and the first and second throttles are configured to cover a majority of the cross-sectional charge flow area of the respective intake passage when in a closed position.

17. The system of claim 8, wherein the intake system includes an intake manifold and each the first and second intake passages extends from the respective first and second intake port to a tube portion joining the first and second intake passages to the intake manifold.

18. The system of claim 17, wherein the tube portion includes a dividing wall therein that separates the charge flow into the first and second intake passages and the first and second throttles are each located in the tube portion at opposite sides of the dividing wall.

19. A system, comprising:
an internal combustion engine including a plurality of cylinders;
an exhaust system configured to receive exhaust from the plurality of cylinders;
a fuel system including a first fuel source operable to provide a first fuel to the plurality of cylinders and a second fuel source operable to provide a second fuel to the plurality of cylinders in addition to the first fuel;
an intake system configured to direct a charge flow to the plurality of cylinders, wherein the intake system is coupled to each of the plurality of cylinders with a first intake passage and a second intake passage connected to corresponding ones of first and second intake ports of the respective cylinder, the first and second intake passages being asymmetric relative to one another to induce a charge flow characteristic in the charge flow passing therethrough and the first and second intake passages each include an electronically actuatable intake valve to control the charge flow therethrough.

20. The system of claim 19, wherein the first intake passage includes at least one swirl characteristic inducing element configured to generate a swirl characteristic in the charge flow received by the combustion chamber and the second intake passage includes at least one tumble characteristic inducing element configured to generate a tumble characteristic in the charge flow received by the combustion chamber.
